(19) United States
(12) Patent Application Publication
(10) Pub. No.: US 2018/0367889 A1
(43) Pub. Date: Dec. 20, 2018

(54) Sound Generator

(71) Applicant: AAC Technologies Pte, Ltd., Singapore city (SG)

(72) Inventor: Xiaojiang Gu, Shenzhen (CN)

(21) Appl. No.: 15/831,926

(22) Filed: Dec. 5, 2017

(30) Foreign Application Priority Data
Jun. 20, 2017 (CN) 201720723751.5

(51) Int. Cl. H04R 1/28; H04R 3/00

(52) U.S. Cl. CPC H04R 1/2811; H04R 2400/11; H04R 3/002; H04R 1/2896

(57) ABSTRACT

The present disclosure provides a sound generator. The sound generator includes a frame including a side wall; a diaphragm fixedly supported by the frame; and a front cover engaging with the frame. The frame further includes several step parts protruding and extending from one side of the side wall close to the front cover. The multiple step parts are spaced from each other for being abutting against the front cover.

### FIELD OF THE PRESENT DISCLOSURE

The present disclosure relates to electro-acoustic transducers, more particularly to a sound generator for radiating audible sounds.

### DESCRIPTION OF RELATED ART

With the rapid development of portable devices like mobile phone etc, people's requirement to the performance of the product is becoming stronger and stronger, and there is a vibration mode of music belt for the music appreciation of the mobile phone, in order to strengthen the entertaining effect, thus, the development of the sounding instrument is accelerating accordingly.

The sound generator of related art comprises a frame, a front cover provided as a cover at the frame, a diaphragm supported at the frame and a voice coil driving the diaphragm to vibrate.

However, in the sound generator of related art, the front cover is made of metal material, its structure is not easy for processing supporting steps, so when the front cover is assembled onto the frame, there is a relatively large gap between a corner location of the front cover and the frame, when the sound generator is exposed to relatively big force, the location is susceptible to depression, thus causing a tonal difference problem of the sound generator.

Therefore it is necessary to provide an improved sound generator for overcoming the above-mentioned disadvantages.

### BRIEF DESCRIPTION OF THE DRAWINGS

Many aspects of the exemplary embodiment can be better understood with reference to the following drawing. The components in the drawing are not necessarily drawn to scale, the emphasis instead being placed upon clearly illustrating the principles of the present disclosure.

FIG. 1 is an illustrative isometric view of a sound generator in accordance with an exemplary embodiment of the present disclosure.

FIG. 2 is an isometric view of a frame of the sound generator in FIG. 1.

FIG. 3 is a cross-sectional view of the frame in FIG. 2.

### DETAILED DESCRIPTION OF THE EXEMPLARY EMBODIMENT

The present disclosure will hereinafter be described in detail with reference to an exemplary embodiments. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

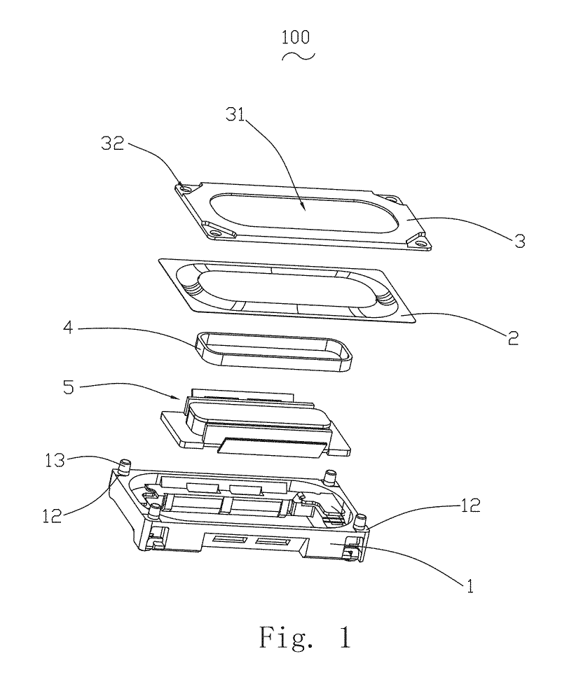

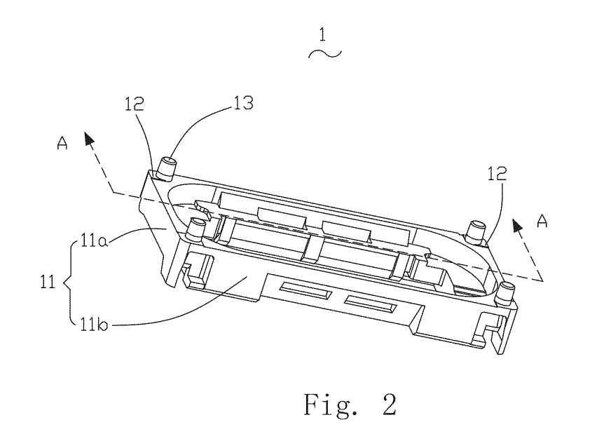

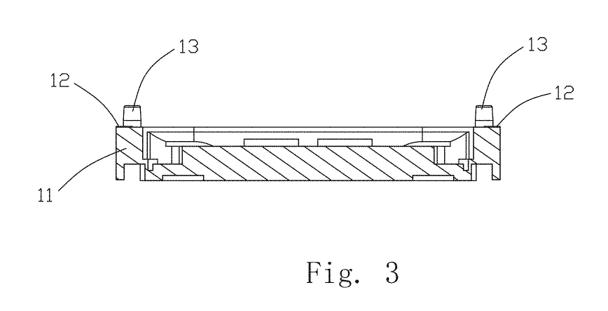

Please refer to FIGS. 1-3, the present disclosure provides a sound generator 100, comprising a frame 1, a diaphragm 2 fixedly supported at the frame 1, a front cover 3 provided as a cover at the frame 1, a voice coil 4 driving the diaphragm 2 to vibrate and produce sound and a magnetic circuit system 5 fixed at the frame 1.

The frame 1 is used to fixedly support the diaphragm 2 and the magnetic circuit system 5, the front cover 3 is provided as a cover at the frame 1 and make the diaphragm 2 switched between the frame 1 and the front cover 3.

The diaphragm 2 is used for vibration and sound production.

The front cover 3 covers the frame 1, the front cover 3 is provided with a sound transmitting hole 31, the sound transmitting hole 31 is provided directly opposite to the diaphragm 2, to form a sounding channel.

The frame 1 of the present disclosure comprises a side wall 11, multiple step parts 12 protruding and extending from one side of the side wall 11 close to the front cover 3 and a positioning column 13 shaped as an extension from the step part 12 to the front cover 3.

Specifically, the side wall 11 comprises multiple and end-to-end connected side walls, a step part 12 is provided at the one side close to the front cover 3 at the joint of every two neighboring sidewalls 11.

The multiple step parts 12 are provided spaced from each other, the front cover 3 abuts with the step parts 12.

The positioning column 13 is used to form positioning of the front cover 3.

More preferably, the front cover 3 is provided with a positioning hole 32 running through on it and matched with the positioning column 13, the positioning hole 32 is provided as sleeved onto the positioning column 13. The structure allows to improve production efficiency and the structural stability in assembly of the sound generator 100.

Taking the frame 1 in rectangle as an example, the side wall 11 comprises two first side walls 11a oppositely provided and two second side walls 11b oppositely provided, the two first side walls 11a and the two second side walls 11b enclose to form a rectangle. Then the step parts 12 is four in number, a step part 12 is provided at a joint (corner) between the neighbor first side walls 11a and second side wall 11b.

Needless to say, the frame 1 is not limited to such shape.

More preferably, the step parts 12 have a height greater than or equal to a thickness of the diaphragm 2.

Because the front cover 3 is provided as a cover at the frame 1, the gap between the front cover 3 and the sidewall 11 of the frame 1 is relatively great at the joint. While the step part 12 is provided to make up the gap, so that when the sound generator 100 is exposed to relatively great pressure, the location where the step parts 12 is pressed to be provided at the front cover 3 will not be depressed, with good pressure resistance performance, it will not cause tonal difference problem, thus improving the acoustic stability of the sound generator 100.

The voice coil 4 is fixed at the diaphragm 2, producing electric sound upon electrification, the magnetic circuit system 5 producing a magnetic field, electric and magnetic fields act together to drive the diaphragm 2 to generate linear vibration and produce sound.

Compared with the prior art, in the sound generator provided by the present disclosure, the protruding step parts are formed at the side close to the front cover at the corner of the side wall, and make the front cover provided as a cover at the side wall abut with the step parts, so as to improve the performance of compression resistance at the corner of the frame, to prevent the tonal difference problem caused by too much compression imposed on the sound generator, thus improving the sounding stability of the sound generator.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A sound generator comprising:
a frame including a side wall;
a diaphragm fixedly supported by the frame;
a front cover engaging with the frame; wherein
the frame further includes multiple step parts protruding and extending from one side of the side wall close to the front cover, the multiple step parts are spaced from each other for being abutting against the front cover.

2. The sound generator as described in claim 1, wherein the side wall comprises multiple and end-to-end connected side walls, the step part is provided at one side close to the front cover at the joint of every two adjacent sidewalls.

3. The sound generator described in claim 1, wherein the side wall comprises two first side walls and two second side walls, the two first side walls and the two second side walls enclose to form a rectangle.

4. The sound generator as described in claim 3, wherein the step parts have a height greater than or equal to a thickness of the diaphragm.

5. The sound generator as described in claim 4, wherein the frame further comprises a positioning column shaped as an extension from the step part to the front cover, the front cover is provided with a positioning hole running through on it and matched with the positioning column, the positioning hole sleeves the positioning column.
